(19) United States
(12) Patent Application Publication
(10) Pub. No.: US 2007/0192403 A1
(43) Pub. Date: Aug. 16, 2007

(54) Method and arrangement for indicating a size restriction of a message

(76) Inventors: Harri Heine, Tampere (FI); Timo Nieminen, Tampere (FI)

Correspondence Address: PERMAN & GREEN, 425 POST ROAD, FAIRFIELD, CT, 06824, US

(21) Appl. No.: 10/598,896

(22) PCT Filed: Mar. 16, 2005
(86) PCT No.: PCT/FI05/50083

§ 371 Date: Sep. 14, 2006

(30) Foreign Application Priority Data
Mar. 16, 2004 (FI) 20045077

(51) Int. Cl. G06F 15/16

(52) U.S. Cl. 709/203

(57) ABSTRACT

The invention relates to indicating the size limit of messages, particularly multimedia messages, to the user. A device according to the invention includes an application program for composing multimedia messages. A multimedia message size limit defined by the network is registered in the device, so that it is available for the application and can be indicated to the user in the application composing multimedia messages.

The invention relates to indicating the size restrictions of messages, particularly multimedia messages, to the user.

At present it is possible to transmit data that may include text, image, moving image, video or sound, or a combination of these. A lot of messages are transmitted through a network between wireless devices. It is known to transmit text-form messages (SMS, Short Message Service) in a GSM (Global System for Mobile Telecommunications) network through a short message service center (SMSC). The short message service center receives the message to be transmitted and transmits it to the receiver immediately when the receiver can be reached. Multimedia messages (MMS, Multimedia Messaging Service) that can contain various forms of data, are respectively transmitted through a multimedia messaging service center (MMSC).

The various data forms contained by multimedia messages have different sizes. For example text-form data can typically be saved in a fairly small space, which makes it easy to process and transmit, because it does not use up the resources of the system or the equipment. As for images, they already require remarkably more space, capacity and power in order to be processed and transmitted in the same way. The largest data that requires most power and uses most storing capacity is data saved in video form.

When a user wishes to send an SMS, he typically edits the message in his mobile phone, selects a receiver and once more accepts the message to be sent to said receiver. The maximum size of a text message to be transmitted is 160 characters. The maximum size of a multimedia message to be transmitted is in principle unlimited, although operators typically define a maximum size for the messages to be transmitted (the maximum size may be e.g. 100 kB). In case the size of a multimedia message is so large that it cannot be transmitted in said network, the user gets an error message for reply. The error message tells that the multimedia message could not be sent, because it is too large.

Nowadays most mobile phones include a camera, and apart from images, also the saving of video-form data in a mobile phone is possible. For example a multimedia message composed of video clips can be sent only in case the size of the created multimedia message does not surpass the size limit for multimedia messages, defined by the operator. Messages and devices become more versatile and common, and longer and larger video clips can be composed by the devices. Moreover, the user may compile the message of several smaller parts, in which case the size of the composed message may surpass the size limit set for a multimedia message to be transmitted. Typically the limitations connected to the transmitting of multimedia messages are not easily available for the users, and therefore they are not generally known.

The object of the invention is to realize an improved and more user-friendly way to inform the user of a message that cannot be transmitted in the network owing to its large size.

The object is achieved by registering the maximum size of messages to be transmitted in the network, so that the maximum size is available for the mobile phone applications and can be indicated for the user already in the user application.

The characteristic novel features of the invention are set forth in the characterizing parts of the independent claims. Other embodiments of the invention are set forth in the dependent claims.

According to an embodiment of the invention, there is produced an arrangement for composing a message for which the network defines a given size limit. The size limit defined by the network is the largest possible size for a message that still can be transmitted in said network. Messages surpassing the size limit cannot be transmitted in said network. The arrangement according to the invention has an application program for composing the message. In addition, the arrangement has a registered size limit defined by the network that is available for the application program. Typically the application program looks up the size limit in a given predetermined location, such as the device memory, where the size limit is registered. Then the looked-up size limit can be indicated for the user in the software application composing the message.

According to an embodiment of the invention, there is realized a method for composing a message for which the network defines a given size limit in order to enable the transmission of said message in said network. In a method according to the embodiment, the elements of the multimedia message are composed by means of one or several application programs provided in the arrangement. The application program can be for example an application recording video image, an application dealing with static camera images or some other application used for editing message data or composing a message. In this embodiment, the message size limit defined by the network is registered in the device, so that it is available for the application program. The size limit can be defined in the application settings, from where the application program can look it up. As an alternative, the size limit can be saved (stored) for example in a system file, in which case any application program can read the size limit. When the application program has looked the size limit information up in the arrangement, the size limit is indicated for the user.

A software according to an embodiment for composing a message, for which the network defines a given size limit for enabling the transmission of messages in said network, includes program elements for looking up the size limit defined by the network and for indicating the size limit for the user. Typically the size limit is indicated for the user in a graphic interface. According to an embodiment, the user interface shows an envelope symbolizing the sending of a message, which envelope is represented as highlighted, when the size of the message that is being composed is equal to or smaller than the known size limit. In case the size limit is surpassed and the message cannot be transmitted, this is indicated for the user for example so that the envelope symbolizing the sending of a message disappears from the screen, or it is represented as crossed-over, flashing or dim.

An advantage of the invention is that the user is already when composing a message aware of the size limit and the transmission-related consequences of surpassing the limit. Thus the user already when composing the message is aware of the relation of the message size to the defined size limit. In addition, the user gets an indication of an oversized message already in the message-writing application program, instead of finding out, only after attempt, error and a received error message that the attempted message size is too large. Thus the user does not even try to send a message that is too large, but may for example select an alternative way of transmission for a large message, or reduce the message size by leaving something out or by editing the message. Furthermore, the system may recommend an alternative way for sending a large message if the size limit is surpassed (e.g. ‘send as mail’).

The invention is described in more detail below with reference to the appended drawings, where

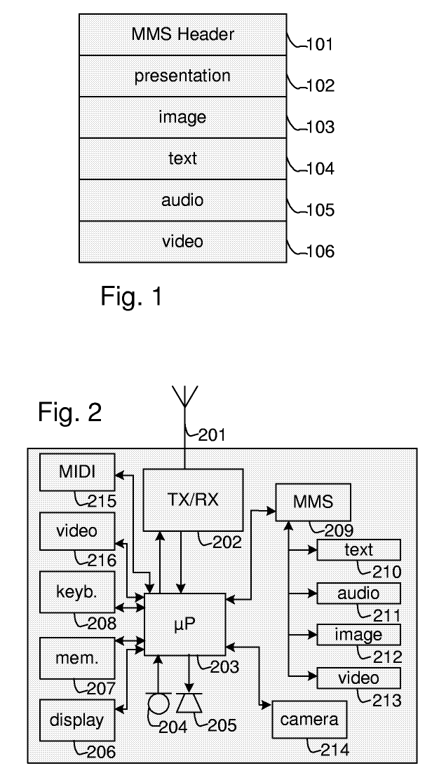

FIG. 1 illustrates a message according to an embodiment of the invention,

FIG. 2 illustrates a device according to an embodiment of the invention,

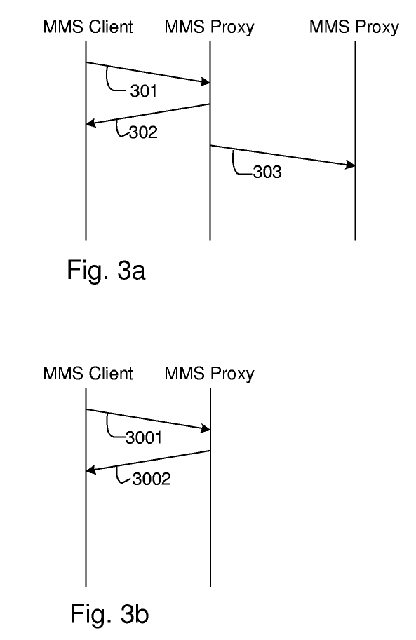

FIG. 3a illustrates a method according to an embodiment of the invention for transmitting messages, and

FIG. 3b illustrates a method according to an embodiment of the invention for transmitting messages.

FIG. 1 illustrates a multimedia message as an example of a message according to the invention. The multimedia message has a header, i.e. an identifier part 101. The identifier part 101 contains information that is needed for transmitting the multimedia message. For example, the identifier 101 contains information of how, when, in which form and according to which protocol the multimedia message is transmitted from the transmitting device to the receiving device. The presentation part 102 of the multimedia message contains instructions for how the contents of the multimedia message are presented in the device. The presentation part 102 is not a mandatory part of a multimedia message: in case the presentation part 102 is not defined in a multimedia message, its contents are presented according to the definitions of the presenting device. The presentation part 102 defines in which order, for how long, how and by what means the multimedia parts of a multimedia message are presented. Typical presentation means are display and sound reproduction means. The presentation part 102 can be realized for instance in the SMIL (Synchronized Multimedia Integration Language) or WML (Wireless Markup Language) programming languages. There can also be several presentation parts 102. In that case one of them is a so-called root part that is indicated by means of a given start parameter.

Moreover, the multimedia message illustrated in FIG. 1 has multimedia parts: an image part, 103, a text part 104, an audio part 105 and a video part 106. A multimedia message may contain several different multimedia parts. The mutual order of the multimedia parts is not significant as such, because their method and order of presentation is defined separately, for example in the above described presentation part 102 or in the settings of the presenting device. The presentation part 102 and the multimedia parts 103-106 constitute the body of the multimedia message.

For composing a multimedia message, there are typically used different components and application programs. FIG. 2 illustrates a mobile phone that can be used for processing multimedia messages. For establishing a contact, the mobile phone includes an antenna 201 and a transmission and reception block 202 provided with separate transmission and reception branches. The transmission and reception block 202 is connected to the antenna 201 by a duplexer, i.e. a branching unit that distributes the transmission and reception turns between the transmission branch and the reception branch. The transmission branch typically includes a transmission unit, an A/D converter and an amplifier. The reception branch typically includes a reception unit, a D/A converter and an amplifier.

The mobile phone has control unit 203, whereby data is processed, and which controls the operation of all components. The memory unit 207 typically includes both permanent memory for storing data and volatile random access memory. In addition, the mobile phone is provided with a multimedia application 209 including means for processing the message text part 210, the audio part 211, the image part 212 and the video part 213. The means for processing the multimedia parts of a multimedia message are typically software means.

As data input elements in the mobile phone of FIG. 2, there are illustrated a microphone 204, a keyboard 208 and a camera 214. Apart from these, typical data input means are mouses as well as surfaces, pens and displays operated by touch input. As data presentation means, the mobile phone includes a display 206, a loudspeaker 205 and a MIDI (Musical Instrument Digital Interface) 215.

Typically the text part 104 of a multimedia message is composed by feeding text from a keyboard 208. The text can also be looked up in a memory 207 or from an external server through an established wireless or fixed connection.

The image part 103 of a multimedia message can be created by manual input through some drawing application. According to an embodiment, there are utilized ready-made images already stored in the device memory 207 or images looked up or ordered from an external server. According to an embodiment, the camera 214 of the device is used for shooting an image, which is possibly edited further by some image editing application.

The audio part 105 of a multimedia message can be composed by means of a microphone 204 and some sound-recording application. The audio data can also be looked up in the device memory unit 207 or from an external server or device. The audio data contained in the audio part 105 of a multimedia message can be reproduced through the loudspeaker 205. Often the devices include more versatile means for processing audio data, for example the MIDI 215 suggested here, that can be used for reproducing more versatile audio data of the audio part 105 of the multimedia message, or for recording audio data as the audio part 105 of the multimedia message.

The video part 106 of a multimedia message is typically recorded by the video camera component 216 included in the device. Also the part 106 of the multimedia message, containing video data, can be recorded in the memory unit 207 of the device and looked up for further usage when necessary. In addition, video data can be received through a connection established from external devices. For presenting video data, there are typically used means employed for presenting both picture and sound.

Because the part 106 of the multimedia message containing video data is typically large in size, let us now observe in more detail how said video part 106 is composed. Respective operations can also be realized in the same way in other applications, components and multimedia message parts. By means of the multimedia application 209, there is composed a message containing video-form data. In this embodiment, the video data is recorded through the video part 213 of the multimedia message application 209, or existing video data is processed by means of the video part 213. The video part 213 includes a software whereby there is created an interface for the user for processing the video data proper. The device according to the invention knows the maximum size for a message to be transmitted. This information can be located in the memory unit 207 of the device, or it can be registered in the system file, in the multimedia application 209, in the data-processing parts 102-106 thereof, or in data-processing software.

According to an embodiment, the information of the maximum size of messages is available for the software to read and use. Thus the software presented for the user can directly indicate for the user when the defined maximum size is surpassed, and the message cannot be transmitted in the network. According to an embodiment, the maximum size of the transmitted message is registered in the memory unit. In that case a video application can look it up, and present an indication of the size of the video data to be processed or produced to the user. The video application can look up and indicate said size information always when the video application is being used. As an alternative, the video application can look up and indicate said size information only when the video application is switched on through the multimedia application. Respectively, the size information registered in connection with the multimedia application, or in a memory part allocated for it, is available for message composing or editing application programs, when said application programs are switched on through the multimedia application. The size information can also be registered in each application program, or only once in the system file of the device, from where the application programs look it up always when being switched on. The registering of the size information in one location only makes it easier to update the size information of the device, because then the updating must only be carried out in one location. Particularly if the size information varies, for instance between different operators, or for instance during the lifecycle of the device, the possibility to update the size information simply and unambiguously is important.

According to an embodiment, on the user's display, there is presented, for instance in the top bar, in addition to other menus and program information, also the information of the size of the message that is being processed. The size of the message can be indicated for example so that in the top bar, there is graphically represented an image of an envelope that turns for example red or dim and/or opens and/or starts to flash and/or gets crossed-over, when the message to be processed reaches the defined maximum size. One possible way to indicate for the user that a multimedia message could not be transmitted in the network, because the size limit defined by the network was surpassed, is to prevent the selection of the “send” option of the browser or application program and for instance to show it as gray in the user interface. The size of the message can also be indicated to the user in some other suitable way. Typically the size is indicated visually, but in addition to information indicated on the display, or instead of it, for example a given sound signal can be used.

The size information can be defined according to a predetermined default value in the data of the transmitting mobile terminal. However, the size of messages transmitted by different networks can vary. Therefore it is useful to look up the current size information in the network. Until the size information is received from the network, some predetermined default value can be used for indicating the message size in the mobile terminal.

Known text messages are transmitted along signaling channels. The capacity of signaling channels is very limited, and consequently also the maximum size of text messages is restricted to 160 characters. For transmitting multimedia messages, there are used data channels. Data channels have a remarkably higher capacity than signaling channels, and the size of the messages transmitted therein can be anything up from hundreds of kilobytes. Moreover, several features can be utilized in the MMS technique, such as user profiles or the conversion of messages into other forms, which are not possible when using the SMS technique. Functions connected to the MMS technique can be achieved within a given marginal without third generation (3G) networks. This can be realized for example by transmitting multimedia messages in packet-form data by using the GPRS (General Packet Radio Service) technique. For example by using the standardized and currently employed EMS (Enhanced Messaging System) technique, it is possible to transmit melodies, simple pictures, sound and animation. The EMS technique is used in the existing infrastructure of the network. In order to fully utilize the MMS technique, both the power of the devices and the infrastructure of the network must be updated. In third generation (3G) networks, the multimedia messages to be transmitted can also include more advanced features, such as video form data flow.

FIG. 3a illustrates how messages are transmitted in an arrangement according to an embodiment of the invention. The transmitter of FIG. 3a, MMS Client, is a mobile terminal. When the transmitter wishes to transmit a message to another receiving mobile terminal the transmitting mobile terminal transmits the message to its messaging server, MMS Proxy, 301. From the messaging server of the transmitter, MMS Proxy, the message is transmitted to the messaging server of the receiver, i.e. MMS Proxy, 303 through some general network. In the employed general network, messages are transmitted according to typical transmission protocols between the messaging servers of the transmitter and the receiver.

When a message should be sent, the transmitting device establishes connection to the messaging server by sending a message transmission request 301. The messaging server, or the so-called proxy server, is located in the network and communicates interactively with the message unit or program of the transmitting device. Said message transmission request is sent on the basis of the URI (Uniform Resource Identifier) of the messaging server. The identifier identifies that messaging server that is available for said transmitting device. For transmitting messages between the messaging server and the mobile terminal, there are typically used the WAP (Wireless Application Protocol) and the WSP/HTTP (Wireless Session Protocol/Hypertext Transfer Protocol) protocols. In connection with the message transmitting request 301, also a multimedia message is transmitted to the messaging server. The transmitting device creates an event identifier to the sent message. The transmitting device and the messaging server use an event identifier, whereby the messages transmitted by them and referring to said event can be identified.

When the messaging server receives a message transmission request, it sends to the transmitter a confirmation message 302. In the confirmation message, there also is transmitted the mode information of the requested function, i.e. information indicating whether the transmission of the requested message was successful. If the transmission was successful according to step 303, the transmitter receives a confirmation message telling that the message is transmitted further. In case the transmission of the message has failed, the transmitter receives an error code indicating the reason of the failure. Reasons for a failure in transmission can be permanent or temporary—for example the messaging server can be temporarily unavailable. Typically the reasons are caused by the network or the server, a setting in either of these, or a failure in the function of an element therein. In case the size of the transmitted message is too large, the transmitter receives, according to the prior art, a confirmation message indicating a notice of the failure in the transmission of the message, as well as of the reason of the failure.

According to an embodiment of the invention, the mobile terminals can, already before the above described step 301, inquire the messaging server the maximum message size transmitted in said external network. Thus the mobile terminal knows the maximum size and can indicate it either in its application program, or when composing or processing the message. A step preceding the transmission 301 of FIG. 3a is illustrated in FIG. 3b. In FIG. 3b, the transmitting mobile terminal transmits to the messaging server an inquiry 3001 of the maximum size of the messages transmitted in the external network that is available. This information can be registered in the messaging server, or the messaging server can further look said information up in an external network. The messaging server sends to the mobile terminal a response message 3002, where it indicates the maximum value of the message size. Thus the mobile terminal receives information of the maximum size of the message transmitted in the network, and can register it so that it is available for the mobile terminal components and/or software.

According to another embodiment, the messaging server can transmit to the mobile terminals a notice of the maximum message size 3002 without a separate request or inquiry from the mobile terminal (3001). The messaging server can transmit said notice to the mobile terminal for example when a new mobile terminal enters its coverage area, or when a mobile terminal under its control is switched on. According to another embodiment, the messaging server can update a possibly changing piece of information for all mobile terminals that transmit messages through said messaging server.

According to an embodiment, a mobile terminal where multimedia messages are composed can send the network a request of the size limit defined by the network. For example in a GSM network, the network size limit can be registered in the network home register from where the network mobile terminals can look the information up. The home register can also transmit for instance an altered piece of information to each mobile terminal under its control. The size information can also be registered in a server located on the network bus, or in a respective storage location, from where the size information is available for the mobile terminals located in the network. In particular, the size information is registered in the network bus in networks where separate switching centers are not employed. The size information defined by the network operator can be transmitted to the network devices in case the size information is changed, or when a device enters the coverage area of the network. Thus the network operator can change the information of the maximum size of a transmitted message for example according to the current load in the network.

1. A device for composing a multimedia message for which a network defines a given multimedia message size limit for enabling transmission of the multimedia message in said network, characterized in that the device includes an application program for creating the multimedia message, and that in the device, there is registered said multimedia message size limit defined by the network, so that said multimedia message size limit is available for the application program, and that the device includes means for producing before an attempt for transmission of the multimedia message in said network is done an indication to a user of the device as a response to a situation in which a size of the multimedia message exceeds said multimedia message size limit.

2. A device according to claim 1, characterized in that the device includes means for inquiring and/or receiving the multimedia message size limit from the network.

3. A device according to claim 2, characterized in that the device includes means for inquiring and/or receiving the multimedia message size limit from at least one of the following: a messaging server, a home register or a server located on the network bus.

4. A device according to claim 1, characterized in that the device is provided with at least one of the following: a memory unit, an application program, a multimedia message application or a system file, for recording the multimedia message size limit.

5. A device according to claim 1, characterized in that the device includes means for inquiring and/or receiving the multimedia message size limit from the network as a response to switching the device on.

6. A device according to claim 1, characterized in that the device includes means for inquiring and/or receiving the multimedia message size limit from the network as a response to an observation that the device has entered the coverage area of a given network or messaging server.

7. A device according to claim 1, characterized in that the device includes means for comparing the multimedia message size limit with the size of a multimedia message composed by the application program, and for indicating the detected size difference in the application program either visually and/or by means of sound.

8. A device according to claim 1, characterized in that the device is the user's mobile device.

9. A device according to claim 1, characterized in that the device is a mobile station.

10. A method for composing a multimedia message for which a network defines a given multimedia message size limit for enabling transmission of the multimedia message in said network, characterized in that
the multimedia message is created by means of an application program,
the multimedia message size limit defined by the network is made available for the application program,
the application program looks up the information concerning the multimedia message size limit, and
as a response to a situation in which a size of the multimedia message exceeds the multimedia message size limit the application program produces an indication to a user of the method before an attempt for transmission of the multimedia message in said network is done.

11. A method according to claim 10, characterized in that the multimedia message size limit defined by the network is inquired and/or received from the network.

12. A method according to claim 11, characterized in that the multimedia message size limit defined by the network is inquired and/or received from one of the following: a messaging server, a home register or a server located on the network bus.

13. A method according to claim 10, characterized in that the multimedia message size limit is registered in one of the following: a memory unit, an application program, a multimedia message application or a system file.

14. A method according to claim 10, characterized in that the multimedia message size limit defined by the network is inquired and/or received from the network always when switching on a device that is capable of processing multimedia messages.

15. A method according to claim 10, characterized in that the multimedia message size limit defined by the network is inquired and/or received from the network always when a device that is capable of processing multimedia messages enters the coverage area of a new network or network switching center.

16. A method according to claim 10, characterized in that the multimedia message size limit defined by the network is compared with the real size of the multimedia message composed by the application program, and when the multimedia message is equally large or larger than the defined multimedia message size limit, the situation is indicated in the application program either visually and/or by sound.

17. A software for composing a multimedia message for which a network defines a given multimedia message size limit for enabling transmission of the multimedia message in said network, characterized in that the software includes software means for obtaining the multimedia message size limit defined by the network for the multimedia message, software means for comparing a size of the multimedia message with the multimedia message size limit, and software means for producing before an attempt for transmission of the multimedia message in said network is done an indication to a user of the software as a response to a situation in which the size of the multimedia message exceeds the multimedia message size limit.

18. A software according to claim 17, characterized in that the software includes software means for requesting and/or receiving from the network the multimedia message size limit defined by the network for the multimedia message.
